(19) United States
(12) Patent Application Publication
(10) Pub. No.: US 2026/0169343 A1
(43) Pub. Date: Jun. 18, 2026

(54) OPTICAL DEVICE

(71) Applicant: Electronics and Telecommunications Research Institute, Daejeon (KR)

(72) Inventors: Jaegyu PARK, Daejeon (KR); Kiwon MOON, Daejeon (KR); Guhwan KIM, Daejeon (KR); Min-su KIM, Daejeon (KR); Jinwoo KIM, Daejeon (KR); Jin Tae KIM, Daejeon (KR); Hong-Seok KIM, Daejeon (KR); Jiho PARK, Daejeon (KR); Jung Jin JU, Daejeon (KR); Tetiana SLUSAR, Daejeon (KR)

(73) Assignee: Electronics and Telecommunications Research Institute, Daejeon (KR)

(21) Appl. No.: 19/421,062

(22) Filed: Dec. 16, 2025

(30) Foreign Application Priority Data
Dec. 17, 2024 (KR) 10-2024-0188557
Nov. 21, 2025 (KR) 10-2025-0177888

(51) Int. Cl. G02F 1/21; G02B 6/293; G02F 1/225

(52) U.S. Cl. CPC G02F 1/212; G02F 1/2255; G02B 6/29352; G02F 1/2257; G02F 2201/122; G02F 2201/128; G02F 2202/20

(57) ABSTRACT

Provided is an optical device. The optical device includes a lower electrode, a lower cladding on the lower electrode, a first input waveguide, a second input waveguide, a first distribution part, a first output waveguide, a second output waveguide, a second distribution part, a first core, and a second core on the lower cladding, an upper cladding covering the first and second cores, and an upper electrode on the upper cladding. The first input waveguide, the second input waveguide, the first core, and the second core are connected to the first distribution part. The first output waveguide, the second output waveguide, the first core, and the second core are connected to the second distribution part.

### CROSS-REFERENCE TO RELATED APPLICATIONS

This U.S. non-provisional patent application claims priority under 35 U.S.C. § 119 of Korean Patent Application No. 10-2024-0188557, filed on Dec. 17, 2024, and Korean Patent Application No. 10-2025-0177888, filed on Nov. 21, 2025, the entire contents of which are hereby incorporated by reference.

### BACKGROUND

The present disclosure herein relates to an optical device, and more particularly, to an optical device including a push-pull Mach-Zehnder interferometric optical modulator having a spiral shape.

In current optical communication technologies, for long-distance and high-bit-rate communication, an optoelectronic modulator based on a Mach-Zehnder interferometer (hereinafter, referred to as an MZI) is mainly used.

The MZI modulator performs optical modulation through an interference phenomenon caused by a change in refractive index of an optical path due to application of a voltage. In addition to change in intensity of light, the MZI modulator may be used to increase in bandwidth in coherent communication, which achieves higher bandwidth by subdividing phase modulation. To improve performance and applicability of the MZI modulator, various studies for miniaturization and high integration are ongoing.

### SUMMARY

The present disclosure provides an optical device including a Mach-Zehnder interferometer having improved performance and applicability.

An embodiment of the inventive concept provides an optical device including: a lower electrode; a lower cladding on the lower electrode; a first input waveguide, a second input waveguide, a first distribution part, a first output waveguide, a second output waveguide, a second distribution part, a first core, and a second core on the lower cladding; an upper cladding covering the first and second cores; and an upper electrode on the upper cladding, wherein the first input waveguide, the second input waveguide, the first core, and the second core are connected to the first distribution part, the first output waveguide, the second output waveguide, the first core, and the second core are connected to the second distribution part, the lower electrode, the first core, and the upper electrode vertically overlap each other, the lower electrode, the second core, and the upper electrode vertically overlap each other, and a polarization direction of the first core and a polarization direction of the second core are opposite to each other.

In an embodiment of the inventive concept, an optical device includes: a substrate; a lower electrode on the substrate; a lower cladding on the lower electrode; a first core and a second core on the lower cladding; an upper cladding covering the first and second cores; and an upper electrode on the upper cladding, wherein the lower electrode, the first core, and the upper electrode vertically overlap each other vertically, the lower electrode, the second core, and the upper electrode vertically overlap each other, and the first core and the second core comprise ferroelectric materials that are polarized in directions different from each other.

In an embodiment of the inventive concept, a method for manufacturing an optical device includes: forming a lower electrode on a substrate; forming a lower cladding on the lower electrode; forming a core layer comprising a ferroelectric material polarized in a first direction on the lower cladding; forming a polling electrode overlapping the core layer; and applying a voltage to the lower electrode and the polling electrode to change a polarization direction of a first portion of the core layer.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a view of an optical device according to some embodiments;

FIG. 1B is a cross-sectional view taken along line I-I′ of FIG. 1A;

FIG. 1C is a cross-sectional view taken along line II-II′ of FIG. 1A;

FIG. 1D is a cross-sectional view taken along line III-III′ of FIG. 1A;

FIGS. 2A and 2B are views illustrating an operation of the optical device according to some embodiments;

FIG. 3A is a graph illustrating a relative value of an intensity of reflected light, which proceeds in a core of the optical device, as a frequency according to some embodiments;

FIG. 3B is a graph illustrating a relative value of an intensity of incident light, which proceeds in the core of the optical device, as a frequency according to some embodiments;

FIG. 3C is a graph illustrating an impedance between an upper electrode and a lower electrode of the optical device as a frequency according to some embodiments;

FIG. 3D is a graph illustrating a group refractive index of the core of the optical device as a frequency according to some embodiments;

FIGS. 4A, 4B, 4C, 4D, 4E, 4F, and 4G are views illustrating a method for manufacturing an optical device according to some embodiments;

FIGS. 5A, 5B, 5C, 5D, 5E, 5F, and 5G are views illustrating a method for manufacturing an optical device according to some embodiments;

FIG. 6 is a view of an optical device according to some embodiments;

FIG. 7 is a view of an optical device according to some embodiments;

FIG. 8 is a view of an optical device according to some embodiments; and

FIG. 9 is a view of an optical device according to some embodiments.

### DETAILED DESCRIPTION

Hereinafter, an optical device according to embodiments of the inventive concept will be described in detail with reference to the drawings.

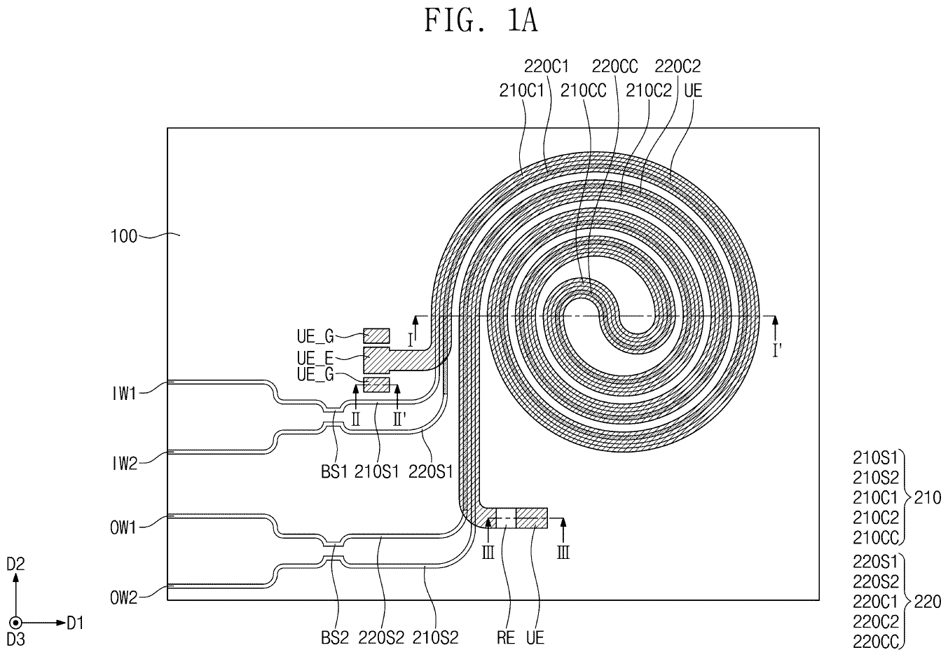

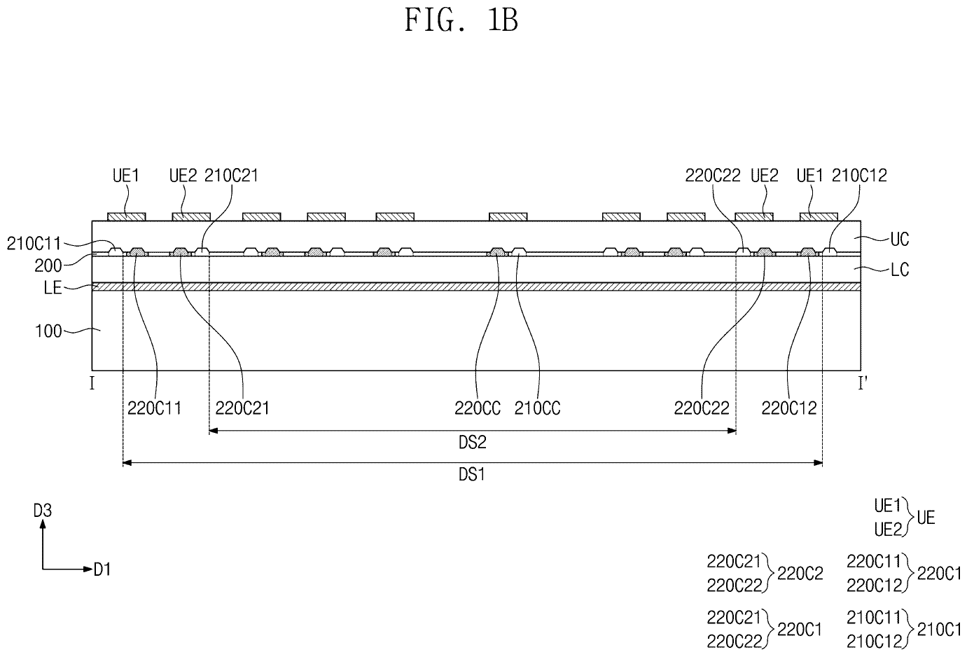

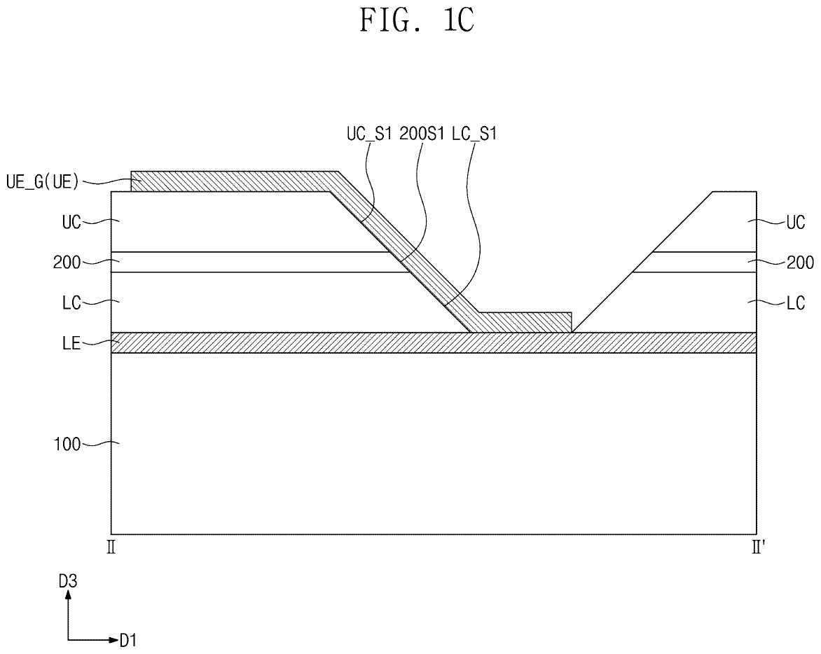

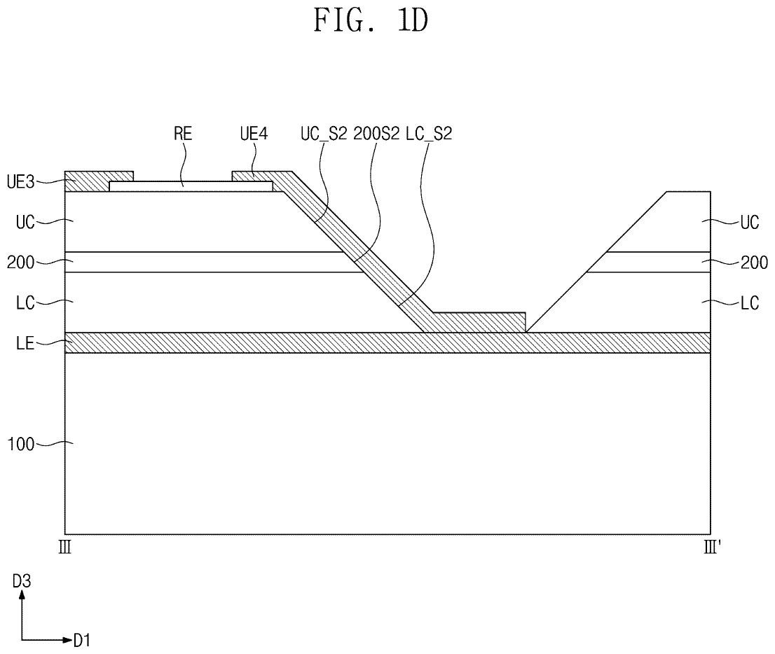

FIG. 1A is a view of an optical device according to some embodiments. FIG. 1B is a cross-sectional view taken along line I-I′ of FIG. 1A. FIG. 1C is a cross-sectional view taken along line II-II′ of FIG. 1A. FIG. 1D is a cross-sectional view taken along line III-III′ of FIG. 1A.

Referring to FIGS. 1A and 1B, a substrate 100 may be provided. In some embodiments, the substrate 100 may be a semiconductor substrate. For example, the substrate 100 may include Si. The substrate 100 may have a shape of a plate expanded along a plane expanded in a first direction D1 and a second direction D2. The first direction D1 and the second direction D2 may intersect each other. For example, the first direction D1 and the second direction D2 may be horizontal directions that are orthogonal to each other.

A lower electrode LE may be provided on the substrate 100. The lower electrode LE may cover a top surface of the substrate 100. The lower electrode LE may include a conductive material. For example, the lower electrode LE may include Au. A thickness of the lower electrode LE in the third direction D3 may be about 0.3 μm or more and about 1.1 μm or less.

A lower cladding LC may be provided on the lower electrode LE. The lower cladding LC may cover a top surface of the electrode LE. The lower cladding LC may include an insulating material. For example, the lower cladding LC may include SiO₂. A thickness of the lower cladding LC in the third direction D3 may be about 1 μm or more and about 5 μm or less.

A core layer 200 may be disposed on the lower cladding LC. The core layer 200 may include a first core 210 and a second core 220. The first core 210 and the second core 220 may protrude from the core layer 200. Each of the first core 210 and the second core 220 may have a spiral shape in a planar perspective of FIG. 1A. Each of the first core 210 and the second core 220 may have a spiral shape with the same central axis. A central portion of the first core 210 and the second core 220 may have an S shape. A thickness of the core layer 200 in the third direction D3 may be about 0.3 μm or more and about 0.6 μm or less.

The core layer 200 may include a ferroelectric material. For example, the core layer 200 may include LiNbO₃ or BaTiO₃. The core layer 200 may include a ferroelectric material polarized in the third direction D3. The third direction D3 may intersect the first direction D1 and the second direction D2. For example, the third direction D3 may be a vertical direction perpendicular to the first direction D1 and the second direction D2. That a material is polarized in the third direction D3 may mean, for example, that a polarization density is in the third direction D3.

The material of the first core 210 may include a ferroelectric material polarized in the third direction D3. The second core 220 may include a ferroelectric material polarized in a direction different from that of the first core 210. The second core 220 may include a ferroelectric material polarized in a direction opposite to the third direction D3.

The first core 210 may include a first linear part 210S1, a first curved part 210C1 connected to the first linear part 210S1, a connection part 210CC connected to the first curved part 210C1, a second curved part 210C2 connected to the connection part 210CC, and a second linear part 210S2 connected to the second curved part 210C2. The first curved part 210C1 of the first core 210 may connect the first linear part 210S1 to the connection part 210CC. The connection part 210CC of the first core 210 may connect the first curved part 210C1 to the second curved part 210C2. The second curved part 210C2 of the first core 210 may connect the second linear part 210S2 to the connection part 210CC.

The first curved part 210C1 of the first core 210 may include a first portion 210C11 and a second portion 210C12, which are spaced apart from each other in the first direction D1 with the second curved part 210C2 and the connection part 210CC therebetween. The second curved part 210C2 of the first core 210 may include a first portion 210C21 and a second portion 210C22, which are spaced apart from each other in the first direction D1 with the connection part 210CC therebetween. A distance DS1 between the first portion 210C11 and the second portion 210C12 of the first curved part 210C1 of the first core 210 may be greater than a distance DS2 between the first portion 210C21 and the second portion 210C22 of the second curved part 210C2 of the first core 210.

The second core 220 may include a first linear part 220S1, a first curved part 220C1 connected to the first linear part 220S1, a connection part 220CC connected to the first curved part 220C1, a second curved part 220C2 connected to the connection part 220CC, and a second linear part 220S2 connected to the second curved part 220C2. The first curved part 220C1 of the second core 220 may connect the first linear part 220S1 to the connection part 220CC. The connection part 220CC of the second core 220 may connect the first curved part 220C1 to the second curved part 220C2. The second curved part 220C2 of the second core 220 may connect the second linear part 220S2 to the connection part 220CC.

The first curved part 220C1 of the second core 220 may include a first portion 220C11 and a second portion 220C12, which are spaced apart from each other in the first direction D1 with the second curved part 220C2 and the connection part 220CC therebetween. The second curved part 220C2 of the second core 220 may include a first portion 220C21 and a second portion 220C22, which are spaced apart from each other in the first direction D1 with the connection part 220CC therebetween. A distance between the first portion 220C11 and the second portion 220C12 of the first curved part 220C1 of the second core 220 may be greater than a distance between the first portion 220C21 and the second portion 220C22 of the second curved part 220C2 of the second core 220.

Each of the connection part 210CC of the first core 210 and the connection part 220CC of the second core 220 may have an S shape in the planar perspective of FIG. 1A.

An upper cladding UC may be provided on the core layer 200. The upper cladding UC may cover the core layer 200. The upper cladding UC may cover the first core 210 and the second core 220. A portion of the upper cladding UC may be disposed between the first core 210 and the second core 220. The upper cladding UC may include an insulating material. The upper cladding UC may include the same material as the lower cladding LC. Each of the upper cladding UC and the lower cladding LC may include a material having a refractive index less than that of the core layer 200. A thickness of the upper cladding UC in the third direction D3 may be about 1 μm or more and about 3 μm or less. The thickness of the upper cladding UC in the third direction D3 may be less than the thickness of the lower cladding LC in the third direction D3.

The upper electrode UE may be disposed on the upper cladding UC. The upper electrode UE may overlap the first core 210 and the second core 220 in the third direction D3. In the planar perspective according to FIG. 1A, the upper electrode UE may have a spiral shape. The upper electrode UE may have a spiral shape with the same central axis as the first core 210 and the second core 220. A central portion of the upper electrode UE may have an S shape. A thickness of the upper electrode UE in the third direction D3 may be about 0.3 or more μm and about 1.5 μm or less. The thickness of the upper electrode UE in the third direction D3 may be the same as the thickness of the lower electrode LE in the third direction D3.

The upper electrode UE may include a first portion UE1 that overlaps the first curved part 210C1 of the first core 210 and the first curved part 220C1 of the second core 220 in the third direction D3. The upper electrode UE may include a second portion UE2 that overlaps the second curved part 210C2 of the first core 210 and the second curved part 220C2 of the second core 220 in the third direction D3. A width of each of the first portion UE1 and the second portion UE2 of the upper electrode UE in the first direction D1 may be about 5 μm or more to about 15 μm or less. A distance between the adjacent first portion UE1 and second portion UE2 of the upper electrode UE may be about 5 μm or more and about 15 μm or less.

The upper electrode UE may include an end UE_E. The upper electrode UE may include a pair of terminal parts UE_G that are spaced apart from each other in the second direction D2 with the end UE_E therebetween. The terminal part UE_G of the upper electrode UE may be in contact with the lower electrode LE. The end UE_E of the upper electrode UE and the pair of terminal portions UE_G may be GSG ports.

The first linear part 210S1 of the first core 210 and the first linear part 220S1 of the second core 220 may be connected to a first distribution part BS1. The second linear part 210S2 of the first core 210 and the second linear part 220S2 of the second core 220 may be connected to a second distribution part BS2.

The first linear part 210S1 of the first core 210, the first linear part 220S1 of the second core 220, the second linear part 210S2 of the first core 210, and the second linear part 220S2 of the second core 220 may not overlap the upper electrode UE in the third direction D3.

The first distribution part BS1 may be connected to a first input waveguide IW1 and a second input waveguide IW2. The second distribution part BS2 may be connected to a first output waveguide OW1 and a second output waveguide OW2.

Referring to FIGS. 1C and 1D, the upper electrode UE and the lower electrode LE may be in contact with each other. The lower cladding LC may include a first inclined surface LC_S1. The core layer 200 may include a first inclined surface 200S1. The upper cladding UC may include a first inclined surface UC_S1. The upper electrode UE may cover the first inclined surface LC_S1 of the lower cladding LC, the first inclined surface 200S1 of the core layer 200, and the first inclined surface UC_S1 of the upper cladding UC. The upper electrode UE may pass through the lower cladding LC, the core layer 200, and the upper cladding UC so as to be in contact with the lower electrode LE.

The lower cladding LC may include a second inclined surface LC_S2. The core layer 200 may include a second inclined surface 200S2. The upper cladding UC may include a second inclined surface UC_S2. The upper electrode UE may cover the second inclined surface LC_S2 of the lower cladding LC, the second inclined surface 200S2 of the core layer 200, and the second inclined surface UC_S2 of the upper cladding UC.

The upper electrode UE may include a third portion UE3 and a fourth portion UE4, which are spaced apart from each other in the first direction D1. The fourth portion UE4 of the upper electrode UE may be in contact with the lower electrode LE. A resistance layer RE connecting the third portion UE3 to the fourth portion UE4 of the upper electrode UE may be provided. The resistance layer RE may include a material having resistivity greater than that of the upper electrode UE.

The optical device according to some embodiments may include the first core 210 and the second core 220 that include the materials polarized in the different directions. Thus, when an electrical signal is applied to the upper electrode UE, the first core 210 and the second core 220 may perform optical phase modulation operations in different directions.

According to some embodiments, the optical device may include a Mach-Zehnder interferometer including the first core 210, the second core 220, the first distribution part BS1, and the second distribution part BS2.

In some embodiments, the lower electrode LE and the upper electrode UE may overlap each other in the third direction D3. Thus, integration of the optical device may be improved, and miniaturization of the optical device may be facilitated.

In the optical device according to some embodiments, each of the first core 210 and the second core 220 may have the spiral shape. Thus, integration of the optical device may be improved, and miniaturization of the optical device may be facilitated.

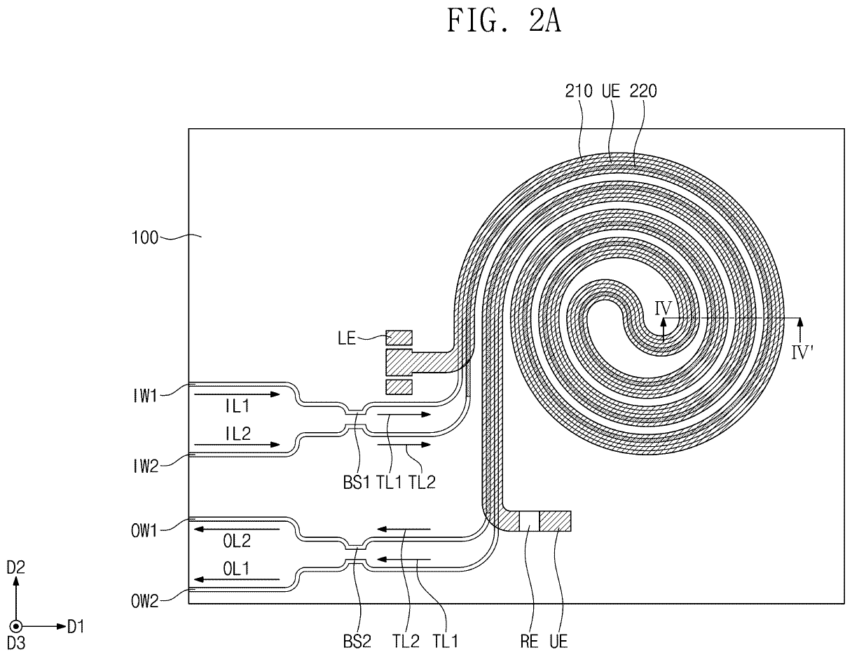

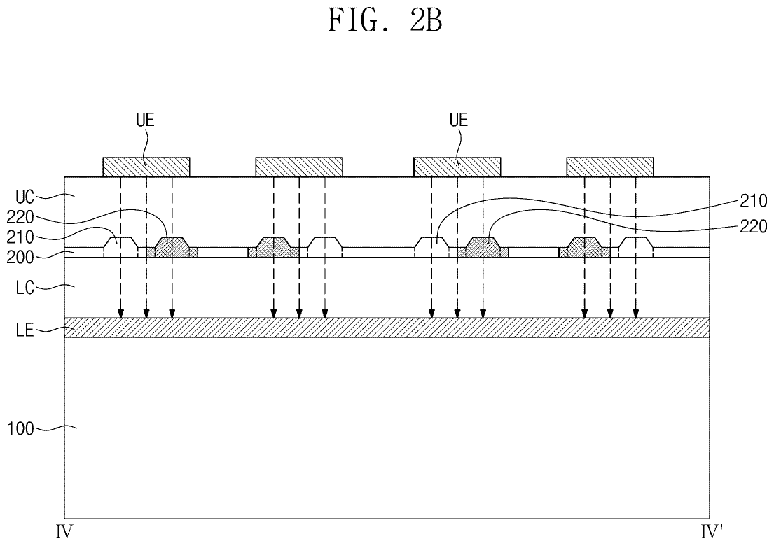

FIGS. 2A and 2B are views illustrating an operation of the optical device according to some embodiments; FIG. 2B is a cross-sectional view taken along line IV-IV′ of FIG. 2A.

Referring to FIGS. 2A and 2B, first input light IL1 may be input through the first input waveguide IW1. The first input light IL1 may be distributed into first traveling light TL1 and second traveling light TL2 by the first distribution part BS1. The first and second traveling light TL1 and TL2 may have the same intensity. The first traveling light TL1 may travel through the first core 210. The second traveling light TL2 may travel through the second core 220.

When the first and second traveling light TL1 and TL2 travel through the first and second cores 210 and 220, an electric field EF may be generated between the upper electrode UE and the lower electrode LE. Refractive indexes of the first core 210 and the second core 220 may be changed due to the electric field EF. Thus, a phase of each of the first traveling light TL1 and the second traveling light TL2 may be changed.

Since polarization directions of the first core 210 and the second core 220 are different from each other, the refractive index changes of the first core 210 and the second core 220 may be different from each other. For example, the refractive index of the first core 210 may be changed by +Δn in the third direction D3, and the refractive index of the second core 220 may be changed by −Δn in the third direction D3. The changes in refractive index experienced by the light traveling through the first core 210 and the second core 220 may be in opposite directions. Thus, an optical modulator of a Mach-Zehnder interferometer substrate may perform a push-pull operation. Since the refractive index changes of the first core 210 and the second core 220 are different from each other, the phase change of the first traveling light TL1 and the phase change of the second traveling light TL2 may also be different from each other.

The first traveling light TL1 and the second traveling light TL2, which pass through the first core 210 and the second core 220, may pass through the second distribution part BS2 and then be distributed into the first output light OL1 and the second output light OL2. The first output light OL1 and the second output light OL2 may have the same intensity.

Second input light IL2 may operate in a manner similar to that of the first input light IL1.

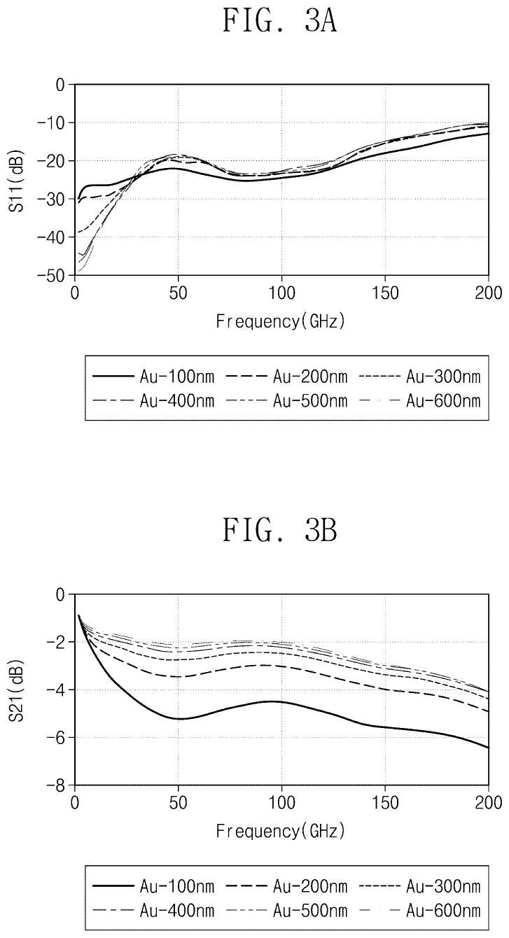

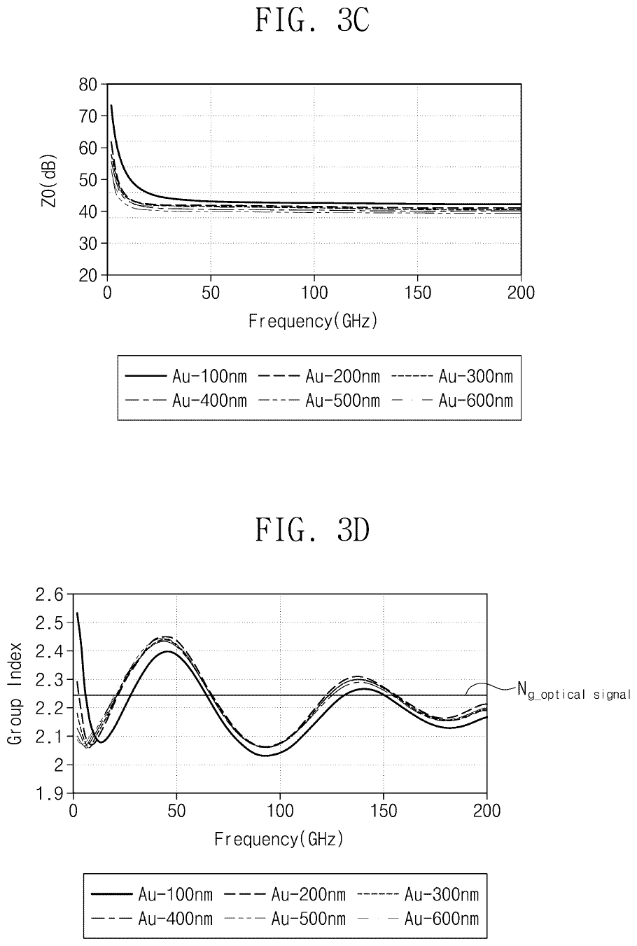

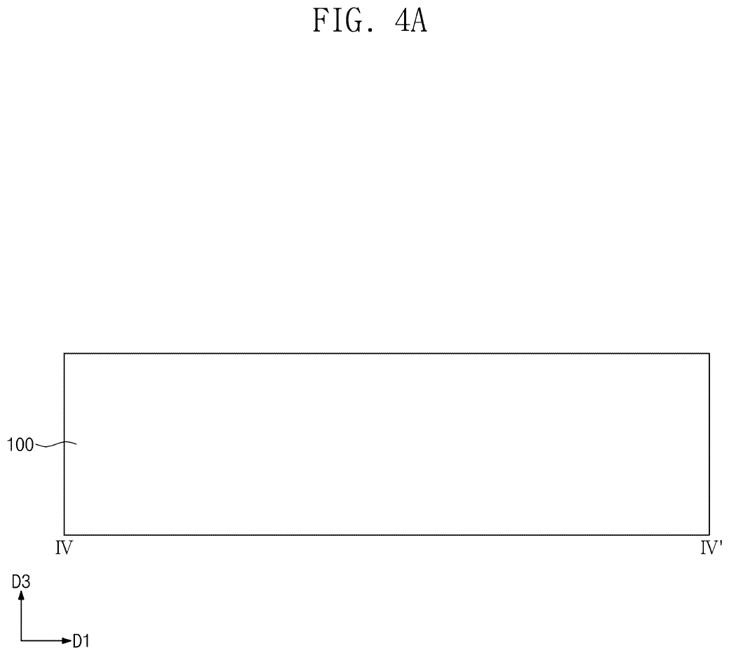

FIG. 3A illustrates relative values of reflection intensities of RF signals flowing through the upper electrode and the lower electrode of the optical device as frequencies according to some embodiments. FIG. 3B illustrates relative values of transmission intensities of RF signals flowing through the upper electrode and the lower electrode of the optical device as frequencies according to some embodiments. FIG. 3C is a graph illustrating an impedance between the upper electrode and the lower electrode of the optical device as a frequency according to some embodiments. FIG. 3D is a graph illustrating a group refractive index of an RF signal of the optical device as a frequency according to some embodiments.

A width of each of the first portion UE1 and the second portion UE2 of the upper electrode UE in the first direction D1 was set to about 10 μm, a length of the spiral portion of the upper electrode UE was set to about 2.1 mm, and a distance between the first portion UE1 and the second portion UE2 of the upper electrode UE, which are adjacent to each other, was set to about 10 μm. The substrate 100 may include Si, each of the lower cladding LC and the upper cladding UC may include SiO₂, and the core layer 200 may include LiNbO₃.

Referring to FIGS. 3A and 3B, it was confirmed that an intensity of the reflected signal was relatively low at about −10 dB in a frequency band greater than about 0 GHz and less than about 200 GHz, and an intensity of the incident signal has a loss of about 6 dB or less around about 200 GHz.

Referring to FIG. 3C, it was confirmed that an impedance is about 40 Ω to about 45 Ω in high-frequency signals.

Referring to FIG. 3D, it was confirmed that the group refractive index of the RF signal matches the group refractive index of the optical signal with a difference of about 5% to about 10%.

It was confirmed that the optical device according to some embodiments operates at an ultra-high speed at a high frequency.

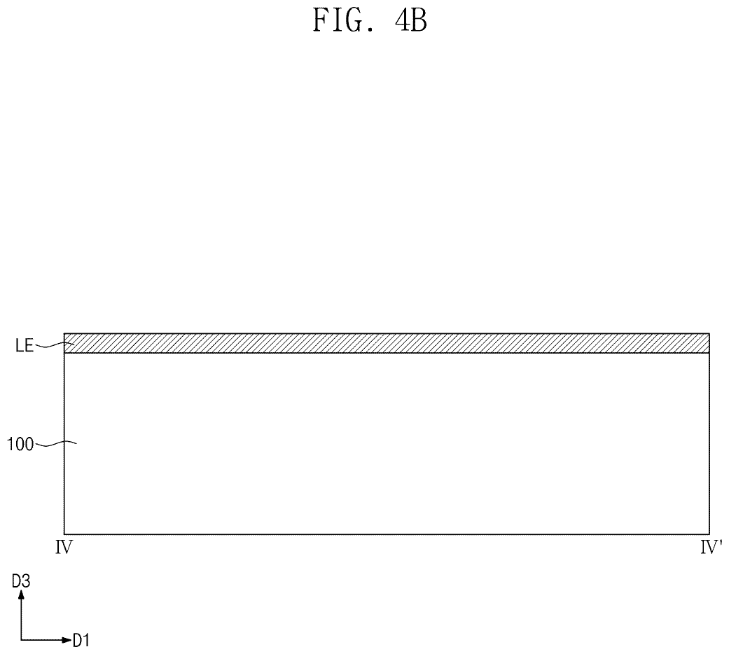

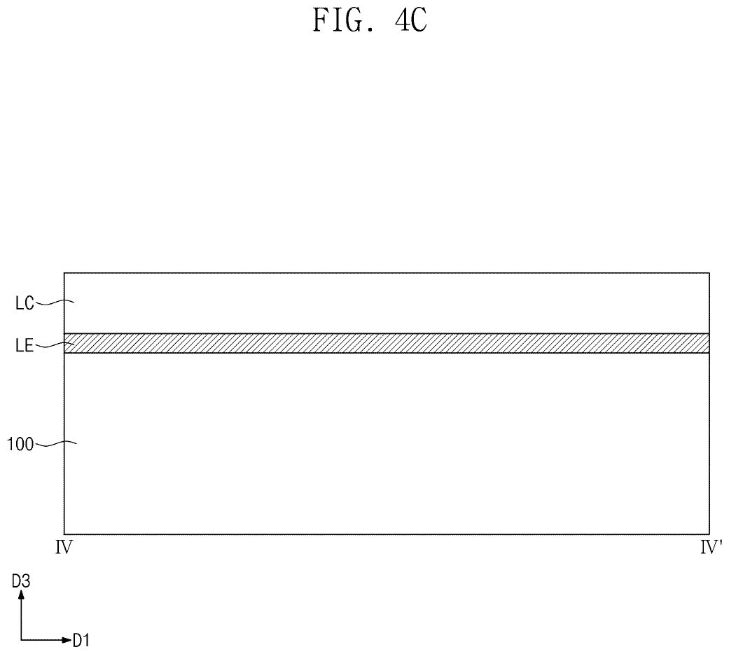

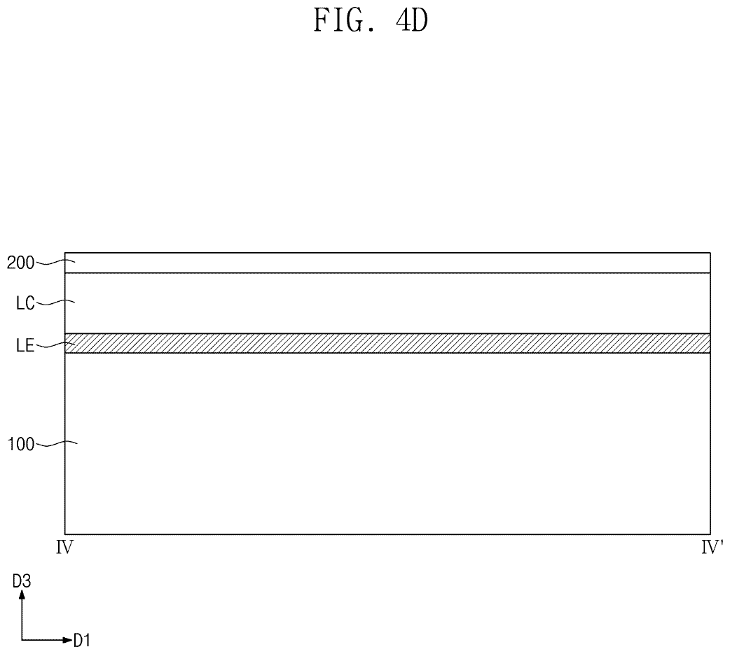

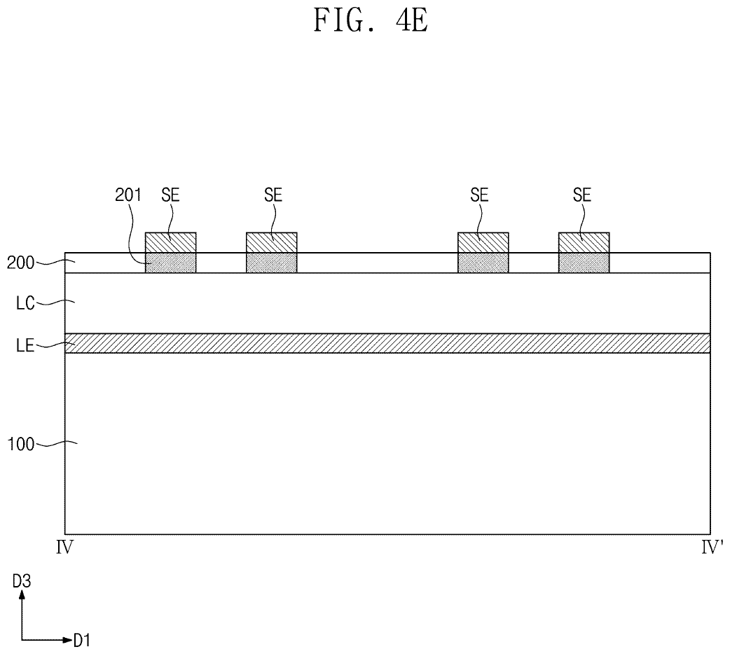

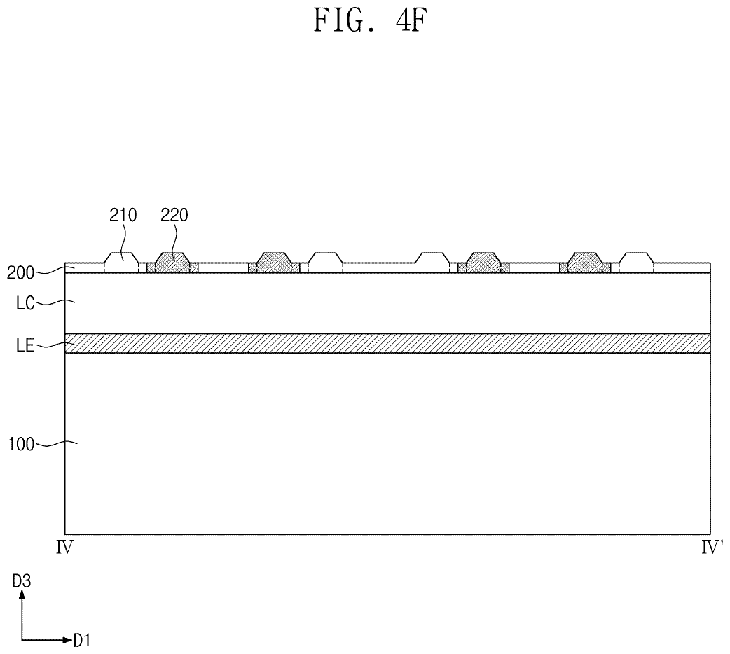

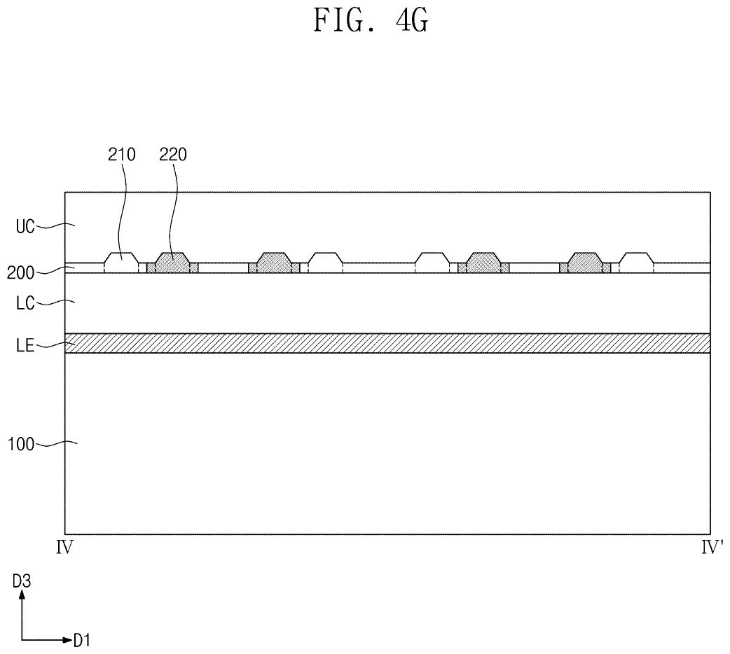

FIGS. 4A, 4B, 4C, 4D, 4E, 4F, and 4G are views illustrating a method for manufacturing an optical device according to some embodiments.

Referring to FIG. 4A, a substrate 100 may be provided.

Referring to FIG. 4B, a lower electrode LE may be formed on the substrate 100.

Referring to FIG. 4C, a lower cladding layer LC may be formed on the lower electrode LE.

Referring to FIG. 4D, a core layer 200 may be formed on the lower cladding LC. The core layer 200 may include a polarized ferroelectric material.

Referring to FIG. 4E, a polling electrode SE may be formed on the core layer 200. In the planar perspective according to FIG. 1A, the polling electrode SE may have a spiral shape. A central portion of the polling electrode SE may have an S shape in the planar perspective according to FIG. 1A. In the planar perspective according to FIG. 1A, the polling electrode SE may have a shape similar to that of the second core 220 described with reference to FIG. 1A.

The polling electrode SE may overlap a first portion 201 of the core layer 200 in the third direction D3. A voltage may be applied to the lower electrode LE and the polling electrode SE. Since the voltage is applied to the lower electrode LE and the polling electrode SE, an electric field may be formed in the first portion 201 of the core layer 200. A polarization direction of the first portion 201 of the core layer 200 may be opposite to that of other portions of the core layer 200 due to the electric field formed within the first portion 201 of the core layer 200.

Referring to FIG. 4F, the polling electrode SE may be removed. A portion of the core layer 200 may be etched. The portion of the core layer 200 may be etched to form a protruding portion. The protruding portion of the core layer 200 may be defined as a first core 210 or a second core 220.

Referring to FIG. 4G, an upper cladding UC may be formed on the core layer 200.

Referring to FIGS. 1A, 1B, 1C, and 1D, a first input waveguide IW1, a second input waveguide IW2, a first output waveguide OW1, a second output waveguide OW2, a first distribution part BS1, and a second distribution part BS2 may be formed on the substrate 100. A resistance layer RE connected to a first upper electrode UE may be formed.

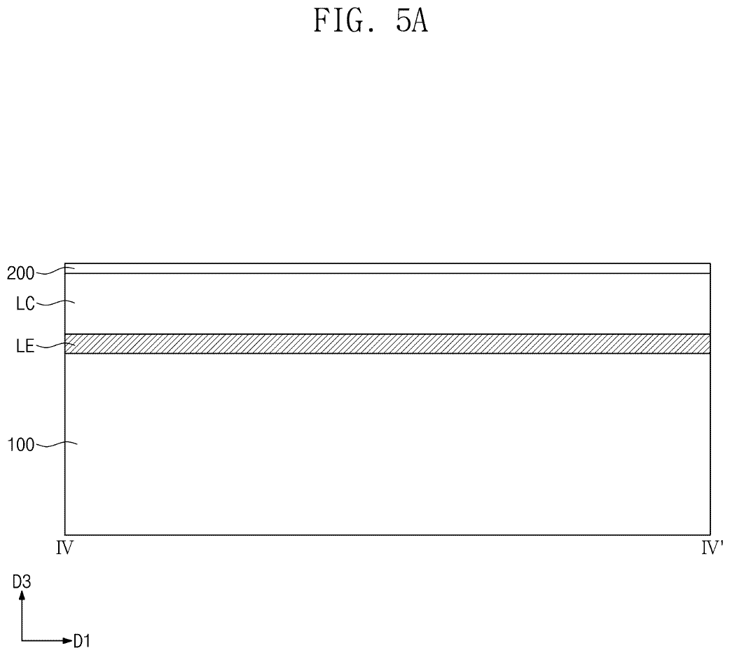

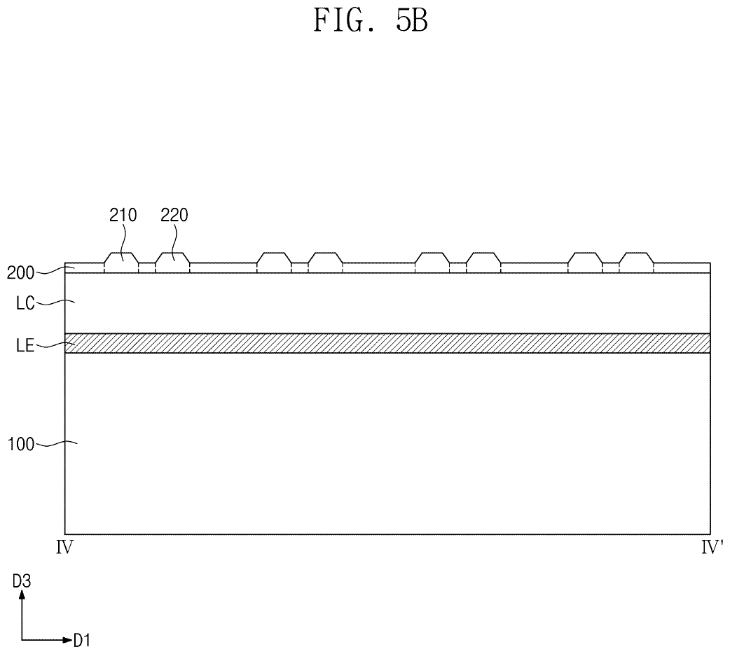

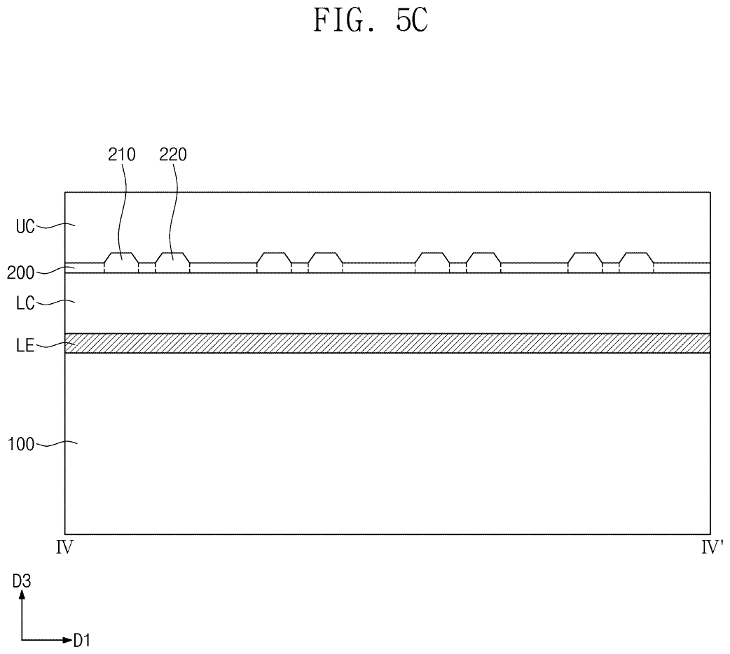

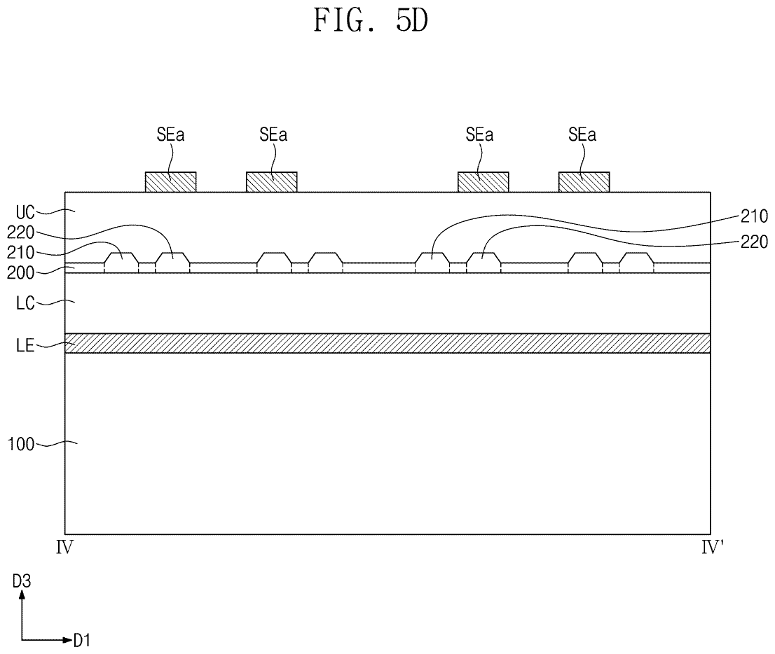

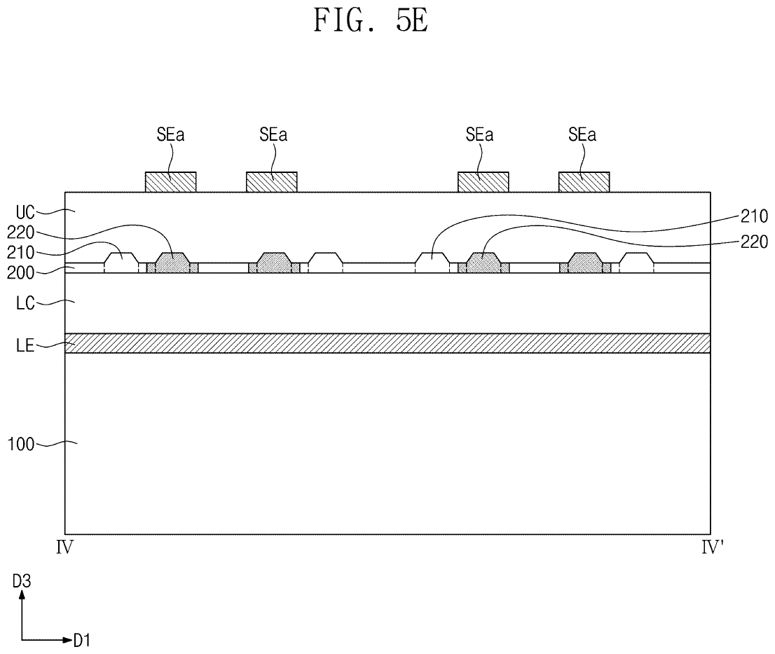

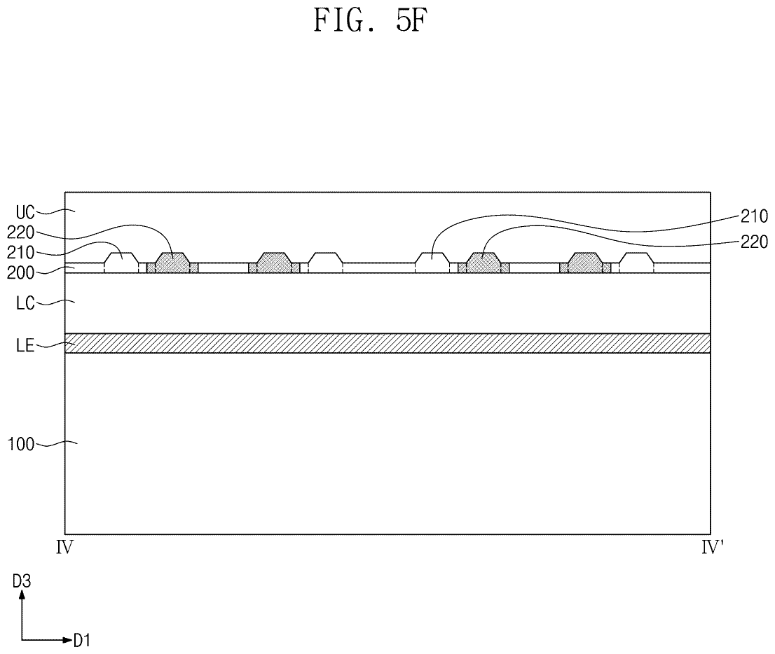

FIGS. 5A, 5B, 5C, 5D, 5E, and 5F are views illustrating a method for manufacturing the optical device according to some embodiments. The method for manufacturing the optical device according to FIGS. 5A, 5B, 5C, 5D, 5E, and 5F may be similar to the method for manufacturing the optical device according to FIGS. 4A, 4B, 4C, 4D, 4E, 4F, and 4G, except for following descriptions.

Referring to FIG. 5A, a substrate 100 may be provided. A lower electrode LE may be formed on the substrate 100. A lower cladding LC may be formed on the lower electrode LE. A core layer 200 may be formed on the lower cladding LC.

Referring to FIG. 5B, a portion of the core layer 200 may be etched. The portion of the core layer 200 may be etched to form a protruding portion. The protruding portion of the core layer 200 may be defined as a first core 210 and a second core 220.

Referring to FIG. 5C, an upper cladding UC may be formed on the core layer 200.

Referring to FIG. 5D, a polling electrode SEa may be formed on the upper cladding UC. The polling electrode SEa may overlap the second core 220 in the third direction D3. The polling electrode SEa may be similar to that described with reference to FIG. 4E, unless otherwise described.

Referring to FIG. 5E, a voltage may be applied to each of the polling electrode SEa and the lower electrode LE. Since the voltage is applied to the polling electrode SEa and the lower electrode LE, an electric field may be formed within the second core 220. A polarization direction of the second core 220 may be changed from that of the first core 210 due to the electric field formed within the second core 220.

Referring to FIG. 5F, the polling electrode SEa may be removed. A signal electrode for transmitting an electrical signal may be formed. In some embodiments, the signal electrode may be the upper electrode UE (see FIG. 1A). Referring to FIGS. 1A, 1B, 1C, and 1D, a first input waveguide IW1, a second input waveguide IW2, a first output waveguide OW1, a second output waveguide OW2, a first distribution part BS1, and a second distribution part BS2 may be formed on the substrate 100. A resistance layer RE connected to a first upper electrode UE may be formed.

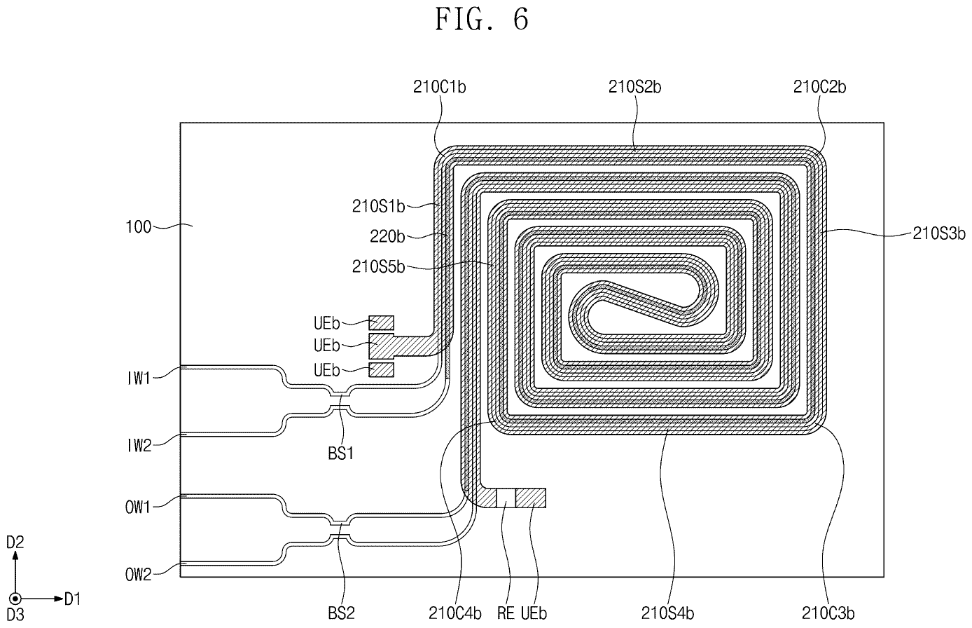

FIG. 6 is a view of an optical device according to some embodiments. An optical device according to FIG. 6 may be similar to the optical devices according to FIGS. 1A, 1B, 1C, and 1D, except for following descriptions.

Referring to FIG. 6, a first core 210b may include a first linear part 210S1b, a second linear part 210S2b, a third linear part 210S3b, a fourth linear part 210S4b, and a fifth linear part 210S5b. The first core 210b may include a first curved part 210C1b connecting the first linear part 210S1b to the second linear part 210S2b, a second curved part 210C2b connecting the second linear part 210S2b to the third linear part 210S3b, a third curved part 210C3b connecting the third linear part 210S3b to the fourth linear part 210S4b, and a fourth curved part 210C4b connecting the fourth linear part 210S4b to the fifth linear part 210S5b.

Each of the first linear part 210S1b, the third linear part 210S3b, and the fifth linear part 210S5b of the first core 210b may have a straight-line shape extending in the second direction D2. Each of the second linear part 210S2b and the fourth linear part 210S4b of the first core 210b may have a straight-line shape extending in the first direction D1. The fifth linear part 210S5b of the first core 210b may be disposed between the first linear part 210S1b and the third linear part 210S3b. Each of the first to fourth curved parts 210C1b, 210C2b, 210C3b, and 210C4b of the first core 210b may have an Euler bend curve shape.

The second core 220b may have a shape similar to that of the first core 210b. The second core 220b may include linear parts and curved parts, and each of the curved parts of the second core 220b may have the Euler bend curve shape. The upper electrode UEb may include linear parts and curved parts, and each of the curved parts of the upper electrode UEb may have the Euler bend curve shape. The Euler bend curve may have the same dimension with no change in curvature.

According to some embodiments, the optical device may include the curved parts in which each of the first core 210b and the second core 220b has the Euler bend curve shape to reduce a change in polarization direction of light passing through the first core 210b and the second core 220b.

According to some embodiments, the optical device may include a spiral shape in which each of the first core 210b and the second core 220b include the linear part so that each of the linear parts has a long length, and each of the curved parts has a short length. Thus, the change in polarization direction of the light passing through the first core 210b and the second core 220b may be reduced.

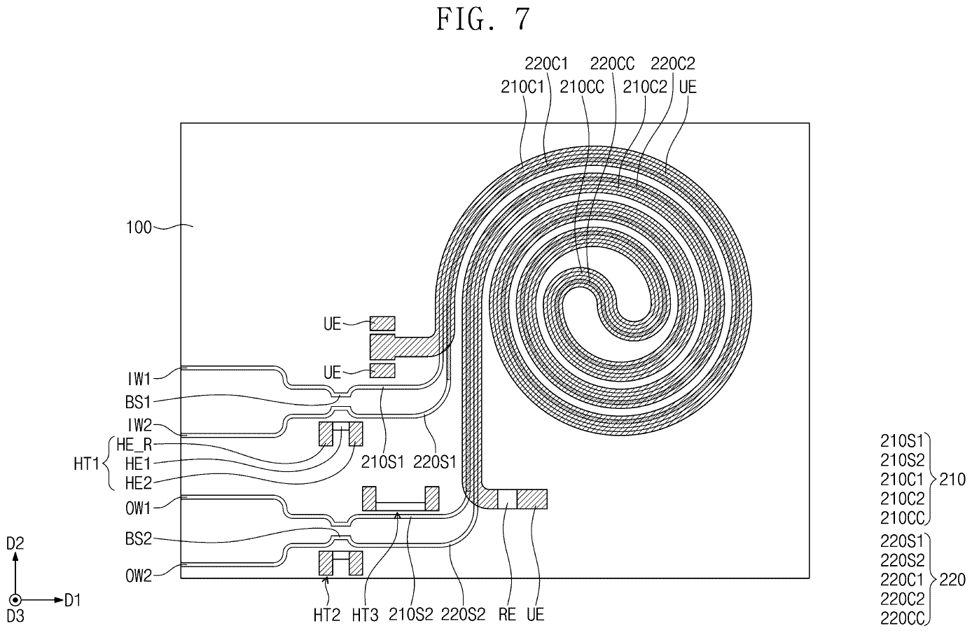

FIG. 7 is a view of an optical device according to some embodiments. An optical device according to FIG. 7 may be similar to the optical devices according to FIGS. 1A, 1B, 1C, and 1D, except for following descriptions.

Referring to FIG. 7, a first heater HT1, a second heater HT2, and a third heater HT3 may be provided. The first to third heaters HT1, HT2, and HT3 may include a first heating electrode HE1, a second heating electrode HE2, and a heating resistor HE_R that connects the first and second heating electrodes HE1 and HE2 to each other.

The first heater HT1 may be adjacent to a first distribution part BS1. The second heater HT2 may be adjacent to a second distribution part BS2. The third heater HT3 may be adjacent to a second linear part 220S2 of a second core 220 or a second linear part 210S2 of a first core 210.

A voltage may be applied between the first heating electrode HE1 and the second heating electrode HE2. Thus, current may flow through the heating resistor HE_R, and thus, heat may be generated in the heating resistor HE_R.

A first distribution part BS1 may be heated by the heat generated in the first heater HT1. The first distribution part BS1 may be heated, and thus, a refractive index of the first distribution part BS1 may be changed. A second distribution part BS2 may be heated by the heat generated in the second heater HT2. The second distribution part BS2 may be heated, and thus, a refractive index of the second distribution part BS2 may be changed.

The second linear part 220S2 of the second core 220 may be heated by heat generated in the third heater HT3. The second linear part 220S2 of the second core 220 may be heated, and thus, a refractive index of the second linear part 220S2 of the second core 220 may be changed.

According to some embodiments, the optical device may heat the first distribution part BS1 and the second distribution part BS2 to change the refractive indexes of the first distribution part BS1 and the second distribution part BS2. The refractive indexes of the first distribution part BS1 and the second distribution part BS2 may be changed to adjust light distribution intensities of the first distribution part BS1 and the second distribution part BS2.

According to some embodiments, the optical device may heat the second core 220 to change a refractive index of the second core 220. The refractive index of the second core 220 may be changed to stably perform a phase change.

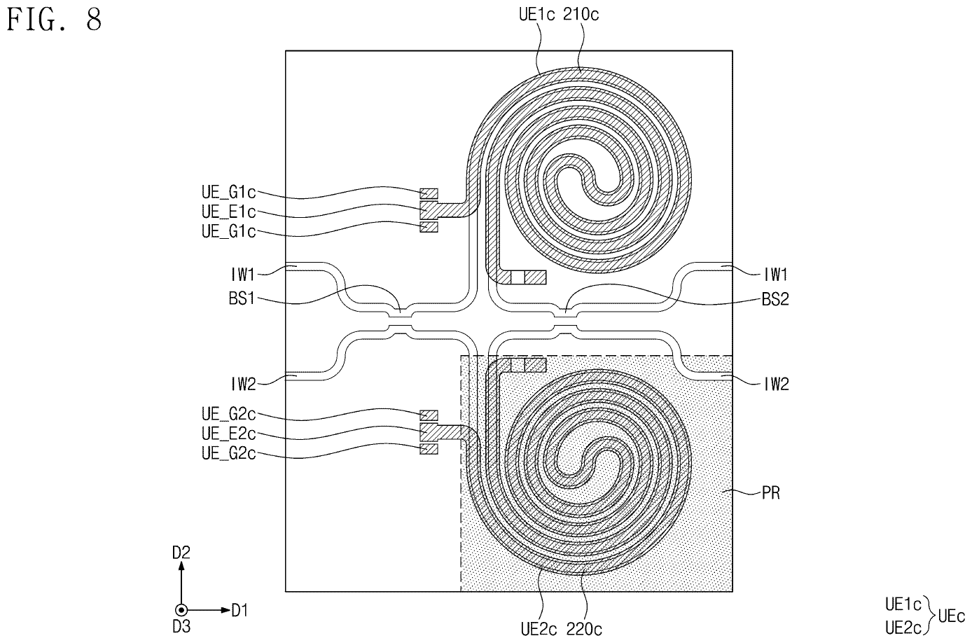

FIG. 8 is a view of an optical device according to some embodiments. An optical device according to FIG. 8 may be similar to the optical devices according to FIGS. 1A, 1B, 1C, and 1D, except for following descriptions.

Referring to FIG. 8, a first distribution part BS1 and a second distribution part BS2 may be disposed between first and second input waveguides IW1 and IW2 and first and second output waveguides OW1 and OW2.

The first distribution part BS1 and the second distribution part BS2 may be spaced apart from each other in the first direction D1. The first and second input waveguides IW1 and IW2, and the first and second output waveguides OW1 and OW2 may be spaced apart from each other in the first direction D1.

A first core 210c and a second core 220c may be spaced apart from each other in the second direction D2. A central axis of the first core 210c and a central axis of the second core 220c may be spaced apart from each other in the second direction D2.

A polarized area PR may be defined on the core layer 200 having a polarized characteristic, and the second core 220c may be disposed on the polarized are PR. An area of the core layer 200 other than the polarized area PR may be polarized in the third direction D3, and the polarized area PR may be an area polarized in a direction opposite to the third direction D3.

An upper electrode UEc may include a first portion UE1c that overlaps the first core 210c in the third direction D3 and a second portion UE2c that overlaps the second core 220c in the third direction D3. The first portion UE1c and the second portion UE2c of the upper electrode UEc may be spaced apart from each other in the second direction D2. Each of the first portion UE1c and the second portion UE2c of the upper electrode UEc may have a spiral shape. A central axis of the first portion UE1c of the upper electrode UEc may be the same as a central axis of the first core 210c. A central axis of the second portion UE2c of the upper electrode UEc may be the same as a central axis of the second core 220c.

A pair of first terminal parts UE_G1c may be disposed to be spaced apart from each other in the second direction D2 with a first end UE_E1c connected to the first portion UE1c of the upper electrode UEc therebetween. The first terminal parts UE_G1c may be exposed portions of the upper electrode UEc.

A pair of second terminal parts UE_G2c may be disposed to be spaced apart from each other in the second direction D2 with a second end UE_E2c connected to the second portion UE2c of the upper electrode UEc therebetween. The second terminal parts UE_G2c may be exposed portions of the upper electrode UEc. The first and second terminal parts UE_G1c and UE_G2c of the upper electrode UEc may be connected to the lower electrode LE in a manner similar to that of FIG. 1C.

A resistance layer RE may be connected to each of the first portion UE1c and the second portion UE2c of the upper electrode UEc. Each of the first portion UE1c and the second portion UE2c of the upper electrode UEc may be connected to the lower electrode BE through the resistance layer RE.

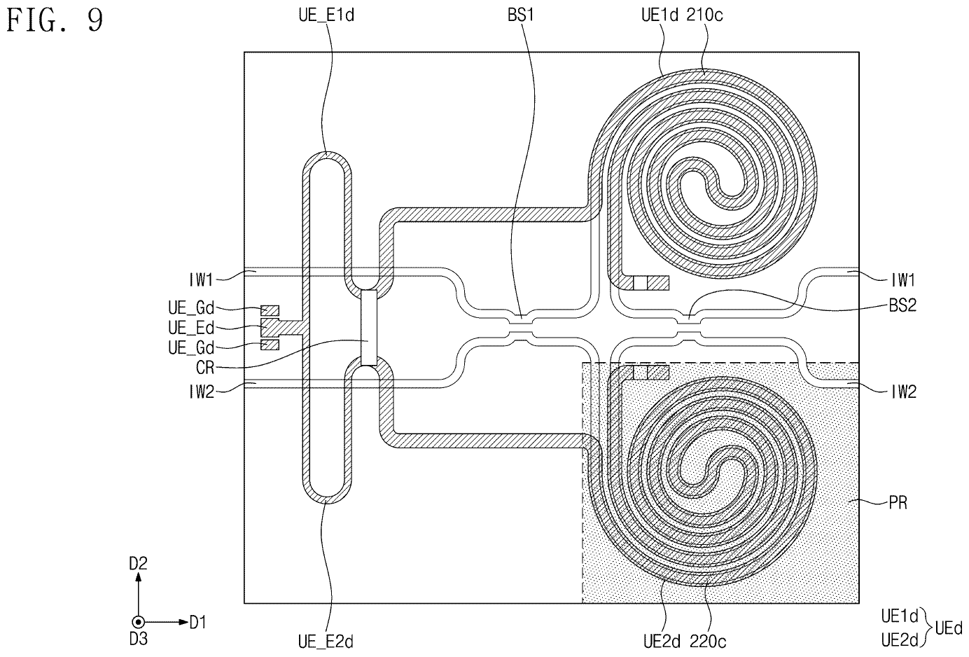

FIG. 9 is a view of an optical device according to some embodiments. An optical device according to FIG. 9 may be similar to the optical device according to FIG. 8, except for following description.

Referring to FIG. 9, a first portion UE1d and a second portion UE2d of an upper electrode UEd may be connected to each other through an end UE_Ed. The first portion UE1d and the second portion UE2d of the upper electrode UEd may be connected to each other through a connection resistor CR. A pair of terminal parts UE_Gd may be provided to be spaced apart from each other in the second direction D2 with the end UEd of the upper electrode UEd therebetween. The end UE_Ed of the upper electrode UEd may be divided into a first portion UE_E1d connected to the first upper electrode UE1d and a second portion UE_E2d connected to the second upper electrode UE2d. An impedance of the first portion UE_E1d and an impedance of the second portion UE_E2d of the upper electrode UEd may be matched through a resistor CR. The first portion UE_E1d and the second portion UE_E2d of the end UE_Ed of the upper electrode UEd may distribute an electrical signal in a 1:1 ratio, and the distributed electrical signals may have the same phase.

The optical device according to the embodiments of the inventive concept may include the first core and the second core, which include the materials polarized in the directions different from each other. Thus, the first core and the second core may perform the optical phase modulation operation in the different directions due to the electric field applied from one upper electrode, and thus, the push-pull phase modulation may be achieved to doubly improve the efficiency of the modulator.

In the optical device according to the embodiments of the inventive concept, the lower electrode and the upper electrode may overlap each other. Thus, the integration of the optical device may be improved, and the miniaturization of the optical device may be facilitated.

The optical device according to embodiments of the inventive concept may include the first core, the second core, and the upper electrode that overlaps both the first core and the second core and has the spiral shape. Thus, the integration of the optical device may be improved, and the miniaturization of the optical device may be facilitated.

The optical device according to the embodiments of the inventive concept may include the curved parts in which the first and second cores have an Euler bend curve shape to reduce the change in polarization direction of the light passing through the first and second cores.

In the optical device according to the embodiments of the inventive concept, the first core and the second core may have the spiral shapes including the linear parts to reduce the change in polarization direction of the light while passing through the curved parts of the first core and the second core.

Although the embodiments of the inventive concept is described with reference to the accompanying drawings, those with ordinary skill in the technical field of the inventive concept pertains will be understood that the present disclosure may be carried out in other specific forms without changing the technical idea or essential features. Therefore, the above-disclosed embodiments are to be considered illustrative and not restrictive.

What is claimed is:

1. An optical device comprising:
a lower electrode;
a lower cladding on the lower electrode;
a first input waveguide, a second input waveguide, a first distribution part, a first output waveguide, a second output waveguide, a second distribution part, a first core, and a second core on the lower cladding;
an upper cladding covering the first and second cores; and
an upper electrode on the upper cladding,
wherein the first input waveguide, the second input waveguide, the first core, and the second core are connected to the first distribution part,
the first output waveguide, the second output waveguide, the first core, and the second core are connected to the second distribution part,
the lower electrode, the first core, and the upper electrode vertically overlap each other,
the lower electrode, the second core, and the upper electrode vertically overlap each other, and
a polarization direction of the first core and a polarization direction of the second core are opposite to each other.

2. The optical device of claim 1, wherein each of the first core, the second core, and the upper electrode has a spiral shape or a straight-line shape.

3. The optical device of claim 1, wherein each of the first core and the second core comprises a ferroelectric material.

4. The optical device of claim 1, wherein the first core and the second core comprise linear parts and curved parts,
wherein each of the curved parts has an Euler bend curve shape.

5. The optical device of claim 4, wherein a length of each of the linear parts is greater than a length of each of the curved parts.

6. The optical device of claim 1, further comprising:
a first heater configured to change a refractive index of the first distribution part; and
a second heater configured to change a refractive index of the second distribution part.

7. The optical device of claim 6, further comprising a third heater configured to change a refractive index of each of the first core and the second core.

8. The optical device of claim 1, wherein the upper electrode comprises:
a first portion vertically overlapping the first core; and
a second portion vertically overlapping the second core.

9. The optical device of claim 8, wherein a polarized area on which the second core and the second portion of the upper electrode are disposed is defined,
wherein the first core and the first portion of the upper electrode are spaced apart from the polarized area.

10. An optical device comprising:
a substrate;
a lower electrode on the substrate;
a lower cladding on the lower electrode;
a first core and a second core on the lower cladding;
an upper cladding covering the first and second cores; and
an upper electrode on the upper cladding,
wherein the lower electrode, the first core, and the upper electrode vertically overlap each other vertically,
the lower electrode, the second core, and the upper electrode vertically overlap each other, and
the first core and the second core comprise ferroelectric materials that are polarized in directions different from each other.

11. The optical device of claim 10, wherein the first core and the second core are polarized in directions opposite to each other.

12. The optical device of claim 10, wherein the upper electrode comprises:
a first portion vertically overlapping the first core; and
a second portion vertically overlapping the second core,
wherein the first portion and the second portion of the upper electrode are connected to each other through a connection resistor.

13. The optical device of claim 12, wherein the upper electrode further comprises an end connected to the first portion and the second portion.

14. The optical device of claim 10, wherein each of the first core and the second core comprises LiNbO₃.

15. The optical device of claim 10, wherein each of the first and second cores has a spiral shape.

16. The optical device of claim 10, wherein the first core comprises a curved part,
wherein the curved part of the first core has an Euler bend curve shape.

17. The optical device of claim 10, wherein a portion of the upper cladding is disposed between the first core and the second core.

18. A method for manufacturing an optical device, the method comprising:
forming a lower electrode on a substrate;
forming a lower cladding on the lower electrode;
forming a core layer comprising a ferroelectric material polarized in a first direction on the lower cladding;
forming a polling electrode overlapping the core layer; and
applying a voltage to the lower electrode and the polling electrode to change a polarization direction of a first portion of the core layer.

19. The method of claim 18, further comprising:
removing the polling electrode;
forming an upper cladding on the core layer; and
forming an upper electrode on the upper cladding.

20. The method of claim 19, further comprising, before the forming of the upper cladding, etching a portion of the core layer to form a first protrusion having a spiral shape and a second protrusion having a spiral shape.
